(19) United States
(12) Patent Application Publication
(10) Pub. No.: US 2015/0379861 A1
(43) Pub. Date: Dec. 31, 2015

(54) System and Method for Automatic Alert and Lockdown

(71) Applicants: Enakshi Deb, Wallingford, PA (US); Daniel Joseph DeMara, II, Brookhaven, PA (US); Maeve Evelyn Hiehle, Swarthmore, PA (US); Sophia Claire Bolinger, Swarthmore, PA (US)

(72) Inventors: Daniel Joseph DeMara, II, Brookhaven, PA (US); Maeve Evelyn Hiehle, Swarthmore, PA (US); Sophia Claire Bolinger, Swarthmore, PA (US); Enakshi Deb, Wallingford, PA (US)

(21) Appl. No.: 14/753,187

(22) Filed: Jun. 29, 2015

Related U.S. Application Data
(60) Provisional application No. 61/998,570, filed on Jun. 30, 2014.

(51) Int. Cl. G08B 25/10; G08B 3/10; G08B 5/38; G08B 27/00

(52) U.S. Cl. CPC G08B 25/10; G08B 27/006; G08B 3/10; G08B 5/38

(57) ABSTRACT

An apparatus and method for generating and transmitting alerts in response to an indication of an emergency in a facility. The apparatus comprises an emergency and mass notification system (EMNS) configured to be connected to a plurality of mobile devices each having an app installed thereon for communication with the EMNS over a network. The EMNS is adapted to receive an authorization code from one of the mobile devices and, in response to receipt of the code, to transmit an alert to law enforcement authorities, transmit an alert to other mobile devices and to manipulate selected lighting and audio systems in the facility.

### CROSS REFERENCE TO RELATED APPLICATIONS

This application claims benefit under 35 U.S.C. §119(e) of Provisional U.S. Patent Application No. 61/998,570, filed on Jun. 30, 2014, and entitled “SYSTEM AND METHOD FOR AUTOMATIC ALERT AND LOCKDOWN,” the content of which is incorporated by reference herein in its entirety.

### BACKGROUND

Emergencies requiring the immediate and quick lockdown of a facility, and the rapid deployment and intervention of law enforcement authorities, have become a commonplace occurrence. For example, the safety of the students, faculty, administration and others in an office complex, school or university, or any other building where people congregate is at great risk when there is a school intrusion by a would be evil doer. Such an intrusion requires that action be taken quickly to reduce or eliminate the risk and/or neutralize the evil doer. Presently, such action is most commonly instituted by a phone call or some other similar alert to the law enforcement authorities and by manual lockdown of the facility. What is needed is an automated alert and lockdown system that can be easily and quickly activated and deactivated from varied, multiple, and/or mobile locations, and that is easy to implement.

### SUMMARY

There is provided a system and method for automatically alerting law enforcement authorities of an emergency situation and for automatically locking down a facility. The system preferably comprises a software application (“app”) that is installed on a wireless mobile device, such as a smartphone or tablet, carried by users. Authorized users of the system, such as assigned faculty or administrators, are provided with an authorization code that can be entered upon launching the app. Once a correct code has been entered, the system is activated and proceeds to automatically:
Alert all users that an emergency has been reported, and, if desired and based on the code entered, identify on the users' devices the emergency procedures to be followed;
Alert law enforcement authorities of the occurrence of an emergency, and, if desired, based on the code entered, identify the nature of the emergency to the authorities. The user's mobile device may also forward information pertaining to the location of the device from which the code was sent; and,
Communicate with the facility's emergency and mass notification system to cause one or more of the following events to automatedly occur: shut down lighting, computers and other equipment in selected locations in the facility, e.g., in the case of a school, in the classrooms; activate strobe lights, for example, in hallways, and other selected locations; play an automated message through the facility's public address system; and/or sound an alarm.

The system is also deactivated via the app, and/or by authorized law enforcement authorities, by communicating with the emergency and mass notification system to automatedly cause the lighting, computer and other equipment to repower/reboot and to power down the strobe lights, alarm(s). For example, a deactivation code may be entered via the app that allows system deactivation, and there may be a requirement that the code be separately and independently entered on two separate devices.

Communication between the mobile devices and the law enforcement authorities may occur via the internet using the facility's WiFi system and/or cellular data communication, and communication between the mobile devices and the building automation system may occur over the facility's local wireless network, or by direct WiFi connection, to the emergency and mass notification system.

### DESCRIPTION OF THE DRAWINGS

FIG. 1 is a block diagram of a system configured according to one aspect of the present invention.

FIG. 2 is a flow chart illustrating activation of the system of FIG. 1 so as to place the facility in a “lockdown” mode.

FIG. 3 is a block diagram illustrating those aspects of the system of FIG. 1 employed to deactivate the system so as to remove the facility from “lockdown” mode.

FIG. 4 is a flow chart illustrating deactivation of the system so as to remove the facility from “lockdown” mode.

### DETAILED DESCRIPTION

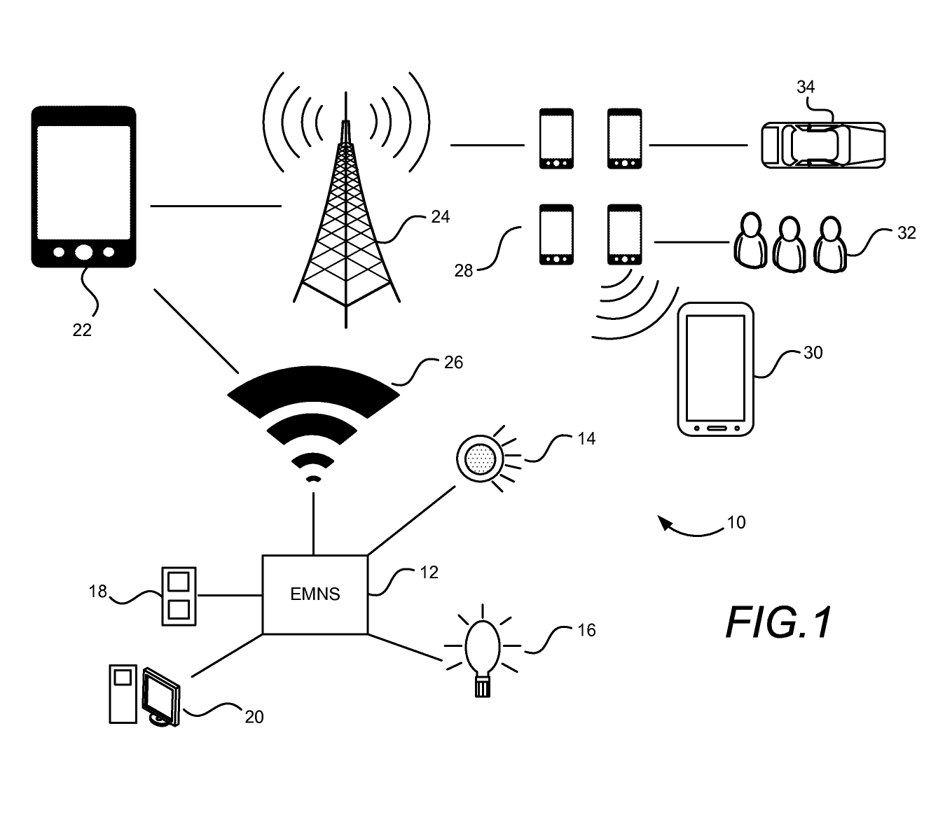

Turning now to the drawings, wherein like numerals represent like elements, there is illustrated in FIG. 1 a block diagram of a system 10, for use in a facility having a emergency and mass notification system (“EMNS”) 12, for automatically alerting law enforcement authorities of an emergency situation and for automatically locking down the facility. An example of EMNS 12 is the Honeywell Building Solutions Instant Alert System, described at https://buildingsolutions.honeywell.com/en-US/solutions/instantalert/Pages/default.aspx. An example of one implementation of the Honeywell Instant Alert system as used in a school facility can be found at http://www.wssd.org/domain/9.

EMNS 12 is in communication with a public address, or paging, system 14 and strobes and other alerts, such as audible alerts, in well-known fashion. EMNS 12 is networkable so as to allow for wired or wireless communication with a network, such as a local network and/or the internet, as shown at 26, also in well known fashion.

According to the invention, there is provided a switch 18, operating under control of EMNS 12, for making/breaking the power connections to building lighting controls for controlling lighting 16 (for classrooms, for example), and the power outlets to which various computer workstations 20 are connected. For example, switch 18 may comprise a mechanical arm that is able to manipulate the circuit breakers, between on and off positions, for the lighting controls for lighting 16 and power outlets for computers 20. Alternatively, switch 18 may comprise a number of switches placed in series with each circuit that is desired to be controlled so as to make and break the connection for each circuit on demand. Though FIG. 1 shows the lighting controls and power outlets for lighting 16 and computers 20 connected to the EMNS 12, it should be pointed out that this is a drawing expedient. Those skilled in the art will appreciate that the lighting controls and computer circuits are controlled via a circuit breaker panel (not shown), the individual circuits of which the switch 18 selectively controls under control of EMNS 12. Thus, EMNS 12 has the ability to send voice messages to the paging system 14, and power up and down the lighting connected to lighting controls 16 and the computers 20.

Mobile devices 22 are equipped with an app that provides an interface and functionality for communicating with the EMNS 12 via network 26 and also for communicating with the mobile devices 28 of others (e.g., faculty and staff) 32 in the facility and law enforcement authorities 34, via a cellular network 24. Communication may also be made to other devices 30, such as to a device for initiating an Amber alert, to a 911 dispatcher, or to other emergency alert systems.

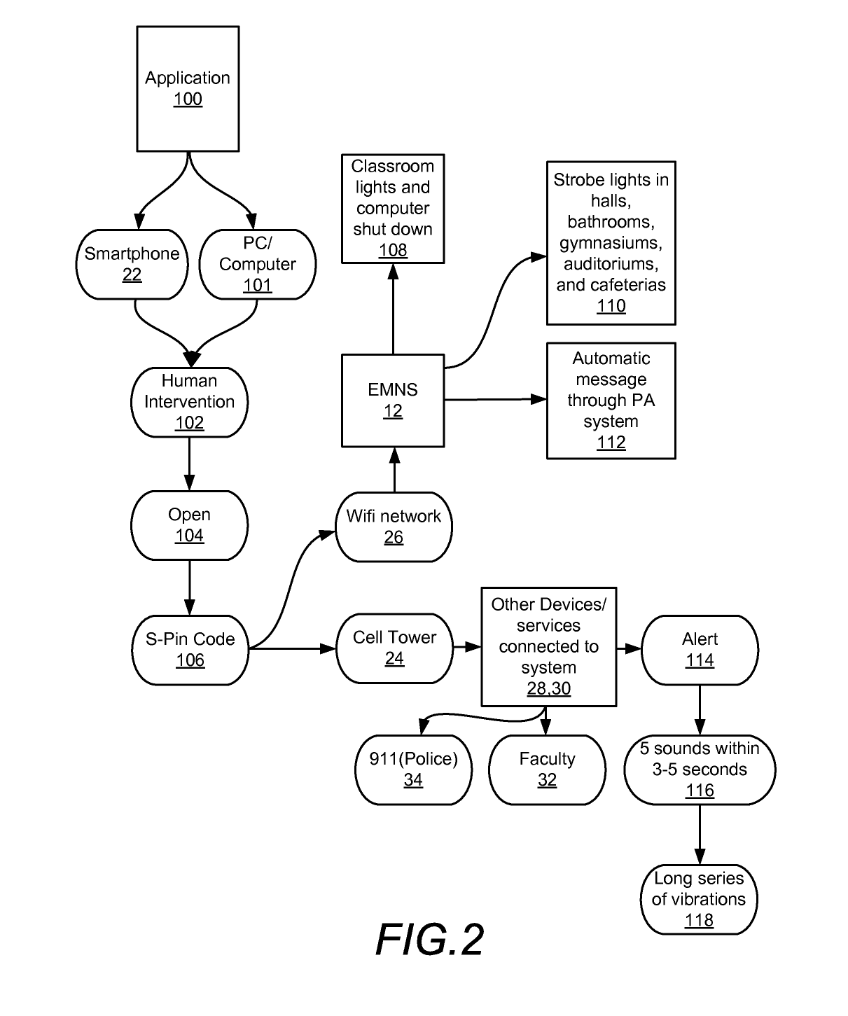

FIG. 2 illustrates one embodiment of the functionality for initiating an automatic alert and lockdown sequence using the system 10. As noted, an app 100 is initially loaded onto mobile devices 22. The app 100 may also be loaded on various workstations 101 in the facility. As shown at 102, the app 100 is instantiated by a user interacting with the mobile device 22, as shown at 102, and opening the app 100, as shown at 104. The user then enters an initiation code into the app 100, such as a five digit PIN, as shown as 106. Only authorized personnel may be provided with the PIN. Once a correct PIN has been entered, the automatic alert and lockdown sequence is begun. The EMNS 12 causes all or selected lighting and computers to be shut down, as shown at 108. The EMNS 12 also activates strobe lights 16 located at various selected locations in the facility, as shown at 110 and sends an automated voice alert message through the facility's public address/announcement system 14. As shown, all of the forgoing occurs as a result of the activated mobile device 22 communicating with the EMNS 12 via the local wireless network 26 in response to entry of the PIN.

Simultaneously, in response to entry of the PIN, the activated mobile device 22 communicates via the cellular network 24 with law enforcement authorities 34 and faculty/staff 32 and to the other devices 30 via the cellular network (and/or via the local wireless network, if desired). Communication may be by text messaging, voice messaging or the like. At the facility, pre-programmed audible alerts 114 may be sounded through the public address/announcement system 14, such as a programmed sequence of sounds or tones 116. Low frequency sounds may also be played so as to provide alerts in the form of vibrations in the facility. All designated users 32 may also be alerted to the emergency via their mobile devices 28. In one embodiment, a message displaying the emergency procedures to be followed is displayed on the devices 28.

In a preferred embodiment, the app transmits the location of the mobile device 22 from which the PIN was entered to law enforcement authorities. In another preferred embodiment, the PIN is indicative of the type of emergency, such that law enforcement authorities are aware of the nature of the situation.

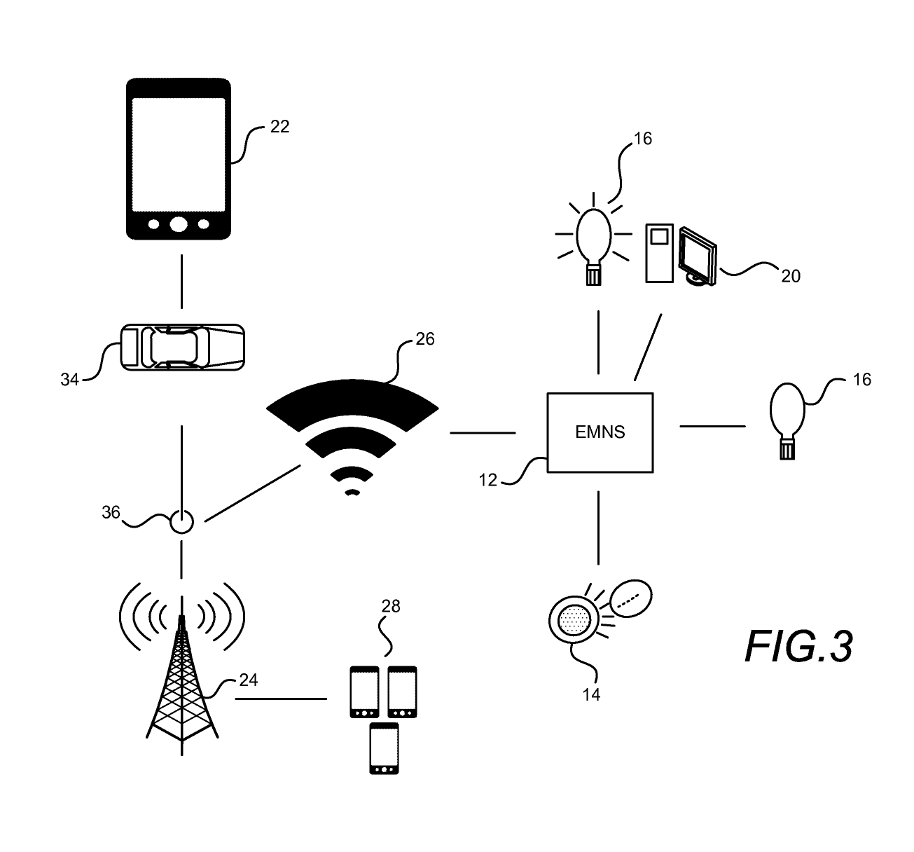

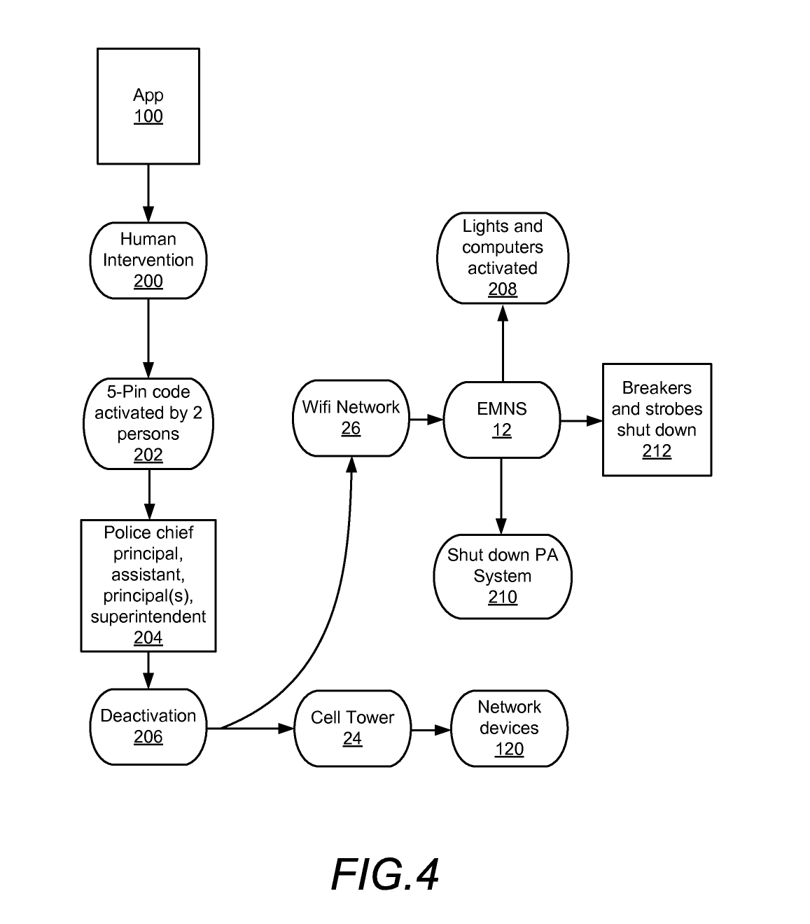

Once the emergency has been abated or declared under control, the deactivation process may begin. Reference is made to FIGS. 3 and 4 in respect to the deactivation process. Again, deactivation is implemented via the app 100. As before, the app 100 is instantiated by a user interacting with the mobile device 22, as shown at 200. However, for safety and security reasons, it is preferred that deactivation require entry of correct PIN(s) by two authorized personnel, 202, such as some combination of law enforcement authorities 34, and facility management/staff. Once the correct PIN(s) has (have) been entered, the deactivation sequence begins, as shown at 206. Communication between the mobile device 22 and the EMNS 12 then proceeds via the network 26, and between the mobile device 22 that instantiated the deactivation, and the mobile devices 28 of other faculty/staff 32 via cellular network 24 so as to alert them that the emergency has been abated. The app 100 instructs the EMNS 12 to activate the lighting and computers that were previously deactivated, discontinue the audible alerts, discontinue the use of the strobe lights, and close the switch(es) 18 as shown at 208, 210 and 212. Power may be restored via switch 36.

While particular embodiments of the invention have been described for illustrative purposes, many modifications and changes are apparent to those skilled in the art. According, the appended claims, rather than the foregoing description, are intended to encompass the true spirit and scope of the invention.

What is claimed:

1. An apparatus comprising an emergency and mass notification system (EMNS) adapted to be located inside a facility and to communicate with and control at least selected lighting and audio systems of the facility and to communicate with law enforcement authorities and a plurality of mobile devices via one or more networks, the mobile devices each having installed thereon an app for allowing the mobile devices to communicate with the EMNS, the EMNS being responsive to information received from one of the mobile devices and, in response to an authorization code entered on the mobile device via the app, to:
i. transmit an alert to the law enforcement authorities;
ii. transmit an alert to the other mobile devices; and,
iii. manipulate selected lighting and audio systems in the facility.

2. The apparatus of claim 1 wherein there are a plurality of authorization codes, each corresponding to a different type of emergency.

3. The apparatus of claim 2 wherein the EMNS transmits the authorization code to the law enforcement authorities.

4. The apparatus of claim 1 wherein the EMNS is adapted to cause selected electrical circuits in the facility to be disconnected from a source of power.

5. The apparatus of claim 1 wherein the EMNS is adapted to manipulate the lighting systems by turning off selected facility lighting and activating emergency strobe lights.

6. The apparatus of claim 1 wherein the EMNS is adapted to manipulate the audio systems by sending an automated voice alert message through a public announcement system of the facility.

7. The apparatus of claim 1 wherein the EMNS is adapted to manipulate the audio systems by generating a pre-programmed sequence of one or both of sound and vibration.

8. The apparatus of claim 1 wherein the alerts are text messages.

9. The apparatus of claim 1 wherein the app is adapted to cause the mobile devices to display emergency procedures through a user interface.

10. The apparatus of claim 1 wherein the alert to the law enforcement authorities comprises information indicative of a geographic location of the mobile device from which an authorization code was entered.

11. The apparatus of claim 1 wherein the EMNS is adapted to transmit information for initiating an Amber alert.

12. The apparatus of claim 1 wherein the app permits entry of the authorization code upon entry of a PIN.

13. A method for causing an emergency and mass notification system to generate and transmit alerts in response to an indication of an emergency in a facility, wherein the EMNS is adapted to communicate with and control at least selected lighting and audio systems of the facility, the method comprising:
receiving at the EMNS information transmitted from one of a plurality of mobile devices indicative of the emergency, wherein the mobile devices have installed thereon an app for allowing the mobile devices to communicate with the EMNS, the information being transmitted from the mobile device to the EMNS in response to an authorization code entered into the mobile device via the app, and,
executing, via the EMNS, in response to receipt of the information, a plurality of actions comprising:
i. transmitting an alert to law enforcement authorities;
ii. transmitting an alert to other users of the system; and
iii. manipulating at least selected lighting and audio systems in the facility.

14. The method of claim 13 wherein there are a plurality of authorization codes, each corresponding to a different type of emergency.

15. The method of claim 13 further comprising transmitting the authorization code to the law enforcement authorities.

16. The method of claim 13 wherein manipulating the audio systems comprises generating a pre-programmed sequence of one or both of sound and vibration.

17. The method of claim 13 wherein the alerts are text messages.

18. The method of claim 13 further comprising displaying emergency procedures through a user interface of the mobile device.

19. The method of claim 13 wherein the alert to law enforcement authorities comprises information indicative of a geographic location of the mobile device from which an authorization code was entered.

20. A method of responding to the occurrence of an emergency in a facility, the method comprising:
instantiating an app installed on a mobile device;
presenting, in response to instantiation of the app, a user interface on the mobile device for entering one of a plurality of authorization codes;
in response to entry of one of the authorization codes, transmitting information from the mobile device to an emergency and mass notification system (EMNS) adapted to control at least selected lighting and audio systems of the facility;
the information transmitted by the mobile device causing the EMNS to:
i. transmit an alert to law enforcement authorities;
ii. transmit an alert to other mobile devices; and,
iii. manipulate at least selected lighting and audio systems in the facility.
